(19) United States
(12) Patent Application Publication
(10) Pub. No.: US 2022/0391961 A1
(43) Pub. Date: Dec. 8, 2022

(54) BUNDLED LISTING GENERATION

(71) Applicant: eBay Inc., San Jose, CA (US)

(72) Inventor: Neeraj Gupta, Milpitas, CA (US)

(21) Appl. No.: 17/339,384

(22) Filed: Jun. 4, 2021

(51) Int. Cl. G06Q 30/06

(52) U.S. Cl. CPC G06Q 30/0631

(57) ABSTRACT

Disclosed are systems, methods, and non-transitory computer-readable media for bundled listing generation. A bundled listing generation system automatically generates bundled listings based on listings posted to an online marketplace. Each bundled listing includes items offered for sale from at least two separate listings posted to the online marketplace, which can be purchased for a single sale price offered by the bundled listing. For example, a bundled listing may offer a shirt from one listing and pants from another listing together as a bundle for a single sale price.

### TECHNICAL FIELD

An embodiment of the present subject matter relates generally to listings provided by an online service and, more specifically, to bundled listing generation.

### BACKGROUND

Online marketplace services allow users to buy and sell items. For example, these services enable users to post listings offering items for sale, as well as view listings posted by other users. In some cases, sellers may bundle items together into a single listing. For example, a bundled listing may include two or more related items and/or items that are commonly purchased together. Offering a bundled listing provides additional ease for both the buyer and seller however, generating bundled listings is often not feasible for a seller in conventional online marketplaces. For example, items may be bundled together in multiple combinations and generating bundled listings for each combination is too burdensome and time consuming for a seller. Sellers are therefore limited to offering a few popular bundled listings. As a result, buyers have limited bundled listings to choose from.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 shows a system for bundled listing generation, according to some example embodiments.

FIG. 2 is a block diagram of a bundled listing generation system, according to some example embodiments.

FIG. 3 is a block diagram of a bundled listings generation component, according to some example embodiments.

FIG. 4 is a flowchart showing a method for bundled listing generation, according to some example embodiments.

FIG. 5 is a flowchart showing a method of selecting individual listings for generating a bundled listing, according to some example embodiments.

FIG. 6 is a block diagram illustrating a representative software architecture, which may be used in conjunction with various hardware architectures herein described.

FIG. 7 is a block diagram illustrating components of a machine, according to some example embodiments, able to read instructions from a machine-readable medium (e.g., a machine-readable storage medium) and perform any one or more of the methodologies discussed herein.

### DETAILED DESCRIPTION

In the following description, for purposes of explanation, various details are set forth in order to provide a thorough understanding of some example embodiments. It will be apparent, however, to one skilled in the art, that the present subject matter may be practiced without these specific details, or with slight alterations.

Reference in the specification to “one embodiment” or “an embodiment” means that a particular feature, structure, or characteristic described in connection with the embodiment is included in at least one embodiment of the present subject matter. Thus, the appearances of the phrase “in one embodiment” or “in an embodiment” appearing in various places throughout the specification are not necessarily all referring to the same embodiment.

For purposes of explanation, specific configurations and details are set forth in order to provide a thorough understanding of the present subject matter. However, it will be apparent to one of ordinary skill in the art that embodiments of the subject matter described may be practiced without the specific details presented herein, or in various combinations, as described herein. Furthermore, well-known features may be omitted or simplified in order not to obscure the described embodiments, Various examples may be given throughout this description. These are merely descriptions of specific embodiments. The scope or meaning of the claims is not limited to the examples given.

Disclosed are systems, methods, and non-transitory computer-readable media for bundled listing generation. An online marketplace service allows users to buy and sell items online. For example, the online marketplace service allows users to post a listing to an online marketplace that lists an item for sale. Other users may view the posted listings and purchase the listed items if so desired. As explained earlier, sellers may bundle multiple items together into a single listing to provide ease for buyers as well increase sales for the seller. Generating bundled listings for each potential combination of items, however, is burdensome and time consuming for a seller. As a result, the number of bundled listings posted to an online marketplace may be limited to a few popular combinations of items.

To alleviate these issues, a bundled listing generation system automatically generates bundled listings based on listings posted to an online marketplace. Each bundled listing includes items offered for sale from at least two separate listings posted to the online marketplace, which can be purchased for a single sale price offered by the bundled listing. For example, a bundled listing may offer a shirt from one listing and pants from another listing together as a bundle for a single sale price.

The bundled listing generation system generates a bundled listing based on listing data from the separate listings for the items being bundled. For example, the bundled listing generation system may use the sale price associated with each of the separate listings to generate a sale price for the bundled listing. The bundled listing generation system may use images from each listing to generate a set of images for the bundled listing. The bundled listing generation system may use item descriptions from each listing to generate an item description for the bundled listing. Feedback, reviews and user comments from the individual listings may also be used to generate listing data for a bundled listing. This provides for a bundled listing that appears as a singular listing for the set of offered items, including a single sale price and item descriptions and images for each offered item.

In some embodiments, a user selects the items to be included in a bundled listing generated by the bundled listing generation system. For example, the bundled listing generation system may provide a user interface that enables a user to select the items and/or listings that the user would like to purchase as a bundle. The bundled listing generation system generates the bundled listing based on the user's selections.

The bundled listing generation system may identify the items to include in a bundled listing. For example, the bundled listing generation system may identify the items based on transaction data associated with a user, such as a user's search history, browsing history, purchase history, and the like. The bundled listing generation system may identify items to include in a bundled listing based on attributes associated with the items and/or listings, such as listing attributes describing the items, sellers, geographic location of the items, and the like. In this type of embodiment, the bundled listing generation system uses the attributes to identify similar items and/or items that are commonly purchased together.

The functionality provided by the bundled listing generation system provides several improvements over current systems. By generating bundled listings based on existing listings posted to an online marketplace, the number and variety of bundled listings offered by the online marketplace is significantly increased, thereby providing a higher quality experience for both sellers and buyers. The bundled listing generation system provides technical improvements to the functioning of computing devices and systems as well. For example, by automating the process of generating bundled listings, the number of listings that are manually created by sellers is greatly reduced, thereby eliminating the computing resources associated with the listing creation process. Further, buyers are able to purchase multiple items in a single purchase, which also significantly decreases the amount of computing resources used to facilitate searching listings and completing additional purchases. When multiplied by the large number of listings posted to an online marketplace, these reductions to computing resource usage represent a significant improvement to overall computing functionality,

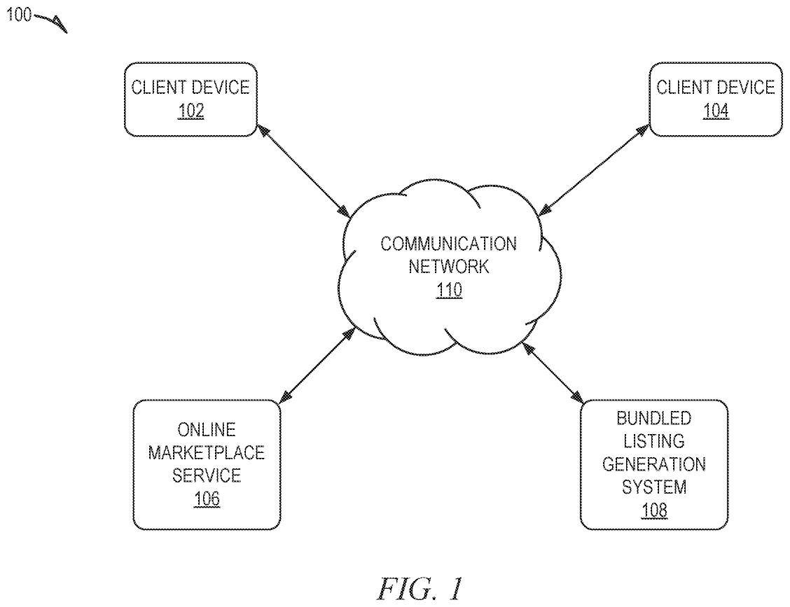

FIG. 1 shows a system 100 for bundled listing generation, according to some example embodiments. As shown, multiple devices (i.e., client device 102, client device 104, online marketplace service 106, and bundled listing generation system 108) are connected to a communication network 110 and configured to communicate with each other through use of the communication network 110. The communication network 110 is any type of network, including a local area network (LAN), such as an intranet, a wide area network (WAN), such as the internet, or any combination thereof. Further, the communication network 110 may be a public network, a private network, or a combination thereof. The communication network 110 is implemented using any number of communication links associated with one or more service providers, including one or more wired communication links, one or more wireless communication links, or any combination thereof. Additionally, the communication network 110 is configured to support the transmission of data formatted using any number of protocols.

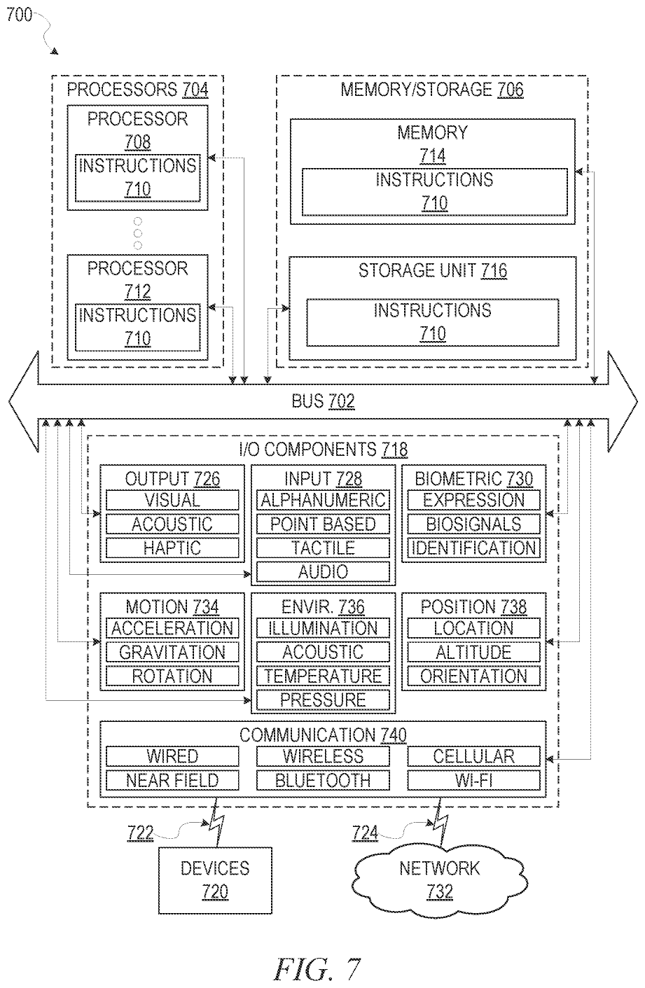

Multiple computing devices can be connected to the communication network 110. A computing device is any type of general computing device capable of network communication with other computing devices. For example, a computing device can be a personal computing device such as a desktop or workstation, a business server, or a portable computing device, such as a laptop, smart phone, or a tablet personal computer (PC). A computing device can include some or all of the features, components, and peripherals of the machine 700 shown in FIG. 7.

To facilitate communication with other computing devices, a computing device includes a communication interface configured to receive a communication, such as a request, data, and the like, from another computing device in network communication with the computing device and pass the communication along to an appropriate module running on the computing device. The communication interface also sends a communication to another computing device in network communication with the computing device.

In the system 100, users interact with the online marketplace service 106 to utilize the services provided by the online marketplace service 106, The online marketplace service 106 provides an online marketplace in which users may post items for sale and purchase items posted for sale by other users. For example, the online marketplace service 106 may include items being auctioned for sale and/or items listed for sale at a set price. Users communicate with and utilize the functionality of the online marketplace service 106 by using the client devices 102 and 104 that are connected to the communication network 110 by direct and/or indirect communication.

Although the shown system 100 includes only two client devices 102, 104, this is only for ease of explanation and is not meant to be limiting. One skilled in the art would appreciate that the system 100 can include any number of client devices 102, 104. Further, the online marketplace service 106 may concurrently accept connections from and interact with any number of client devices 102, 104. The online marketplace service 106 supports connections from a variety of different types of client devices 102, 104, such as desktop computers; mobile computers; mobile communications devices, e.g., mobile phones, smart phones, tablets; smart televisions; set-top boxes; and/or any other network enabled computing devices. Hence, the client devices 102 and 104 may be of varying type, capabilities, operating systems, and so forth.

A user interacts with the online marketplace service 106 via a client-side application installed on the client devices 102 and 104. In some embodiments, the client-side application includes a component specific to the online marketplace service 106. For example, the component may be a stand-alone application, one or more application plug-ins, and/or a browser extension. However, the users may also interact with the online marketplace service 106 via a third-party application, such as a web browser, that resides on the client devices 102 and 104 and is configured to communicate with the online marketplace service 106. In either case, the client-side application presents a user interface (UI) for the user to interact with the online marketplace service 106. For example, the user interacts with the online marketplace service 106 via a client-side application integrated with the file system or via a webpage displayed using a web browser application.

The online marketplace service 106 is one or more computing devices configured to facilitate an online marketplace (e.g., EBAY, AMAZON, etc.) in which users may post items for sale and purchase items posted for sale by other users. For example, the online marketplace service 106 provides a user interface that enables users to view listings posted to the online marketplace service 106. Each listing provides details for an item or items listed for sale. For example, the listing may include an item description, images, sale price, current bid price, auction time remaining, shipping options, aspects, customer reviews, etc.

The online marketplace service 106 may further provide functionality that enables a user to purchase, submit an offer, and/or bid on an item listed for sale. For example, the online marketplace service 106 may provide user interface elements (e.g., button, text fields, etc.) that a user may use to select to purchase an item, place a bid, etc., as well as provide their financial (e.g., credit card number, bank account number) and personal information (e.g., shipping address, billing address, etc.) to complete the purchase. To view listings and/or purchase bid on listed items, a user may create a user account with the online marketplace service 106.

To list an item for sale on the online marketplace, a user creates a user account with the online marketplace service 106. The user account may include the user's personal information (e.g., name, address, email address, phone number, etc.) and financial information (e.g., credit card information, bank account information, etc.). Once the user has created a user account, the user may then use their user account to utilize the functionality of the online marketplace service 106, including listing an item for sale on the online marketplace.

The online marketplace service 106 provides users with a listing interface that enables a user to create a new listing as well as provide listing data for the listing. For example, the listing interface may include data fields that prompt the user to provide specified information for the listing, such as the sale price, item description, listing title, images, shipping cost, return policy, aspects, etc. The listing interface may also include user interface elements, such as buttons, that enable the user to submit and/or post a completed listing. That is, the user may post the listing after the user has filled in the data fields included in the listing interface.

As explained earlier, sellers may bundle multiple items together into a single listing to provide ease for buyers as well increase sales. Generating bundled listings for each potential combination of items, however, is burdensome and time consuming for a seller. As a result, the number of bundled listings posted to an online marketplace may be limited to a few popular combinations of items.

To alleviate these issues, the online marketplace service 106 utilizes the functionality of the bundled listing generation system 108 to automatically generate bundled listings based on listings posted to an online marketplace. Although the bundled listing generation system 108 and the online marketplace service 106 are shown as separate entities, this is just for ease of explanation and is not meant to be limiting. In some embodiments, the bundled listing generation system 108 is incorporated as part of the online marketplace service 106.

A bundled listing is a listing that includes items offered for sale from at least two separate listings posted to the online marketplace, which can be purchased for a single sale price offered by the bundled listing. For example, a bundled listing may offer a shirt from one listing and pants from another listing together as a bundle for a single sale price.

The bundled listing generation system 108 generates a bundled listing based on listing data from the separate listings for the items being bundled. For example, the bundled listing generation system 108 accesses listing data from the online marketplace service 106, such as the sale price associated with each of the separate listings, the item descriptions, images, listing title, and the like. The bundled listing generation system 108 uses the listing data to generate new listing data for the bundled listing. For example, the bundled listing generation system 108 may use the sale price of the individual listings to generate a sale price for the bundled listing. The bundled listing generation system 108 may use images from each listing to generate a set of images for the bundled listing. The bundled listing generation system 108 may use item descriptions from each listing to generate an item description for the bundled listing. This provides for a bundled listing that appears as a singular listing for the offered items, including a single sale price, item description, images, title, and the like.

In some embodiments, a user selects the items to be included in a bundled listing generated by the bundled listing generation system 108. For example, the bundled listing generation system 108 may provide a user interface that enables a user to select the items and/or listings that the user would like to purchase as a bundle. The bundled listing generation system 108 generates the bundled listing based on the user's selections.

The bundled listing generation system 108 may identify the items to include in a bundled listing. For example, the bundled listing generation system 108 may identify the items based on transaction data associated with a user, such as a user's search history, browsing history, purchase history, and the like. The bundled listing generation system 108 may identify items to include in a bundled listing based on attributes associated with the items and/or listings, such as listing attributes describing the items, sellers, geographic location of the items, and the like. In this type of embodiment, the bundled listing generation system 108 uses the attributes to identify similar items and/or items that are commonly purchased together.

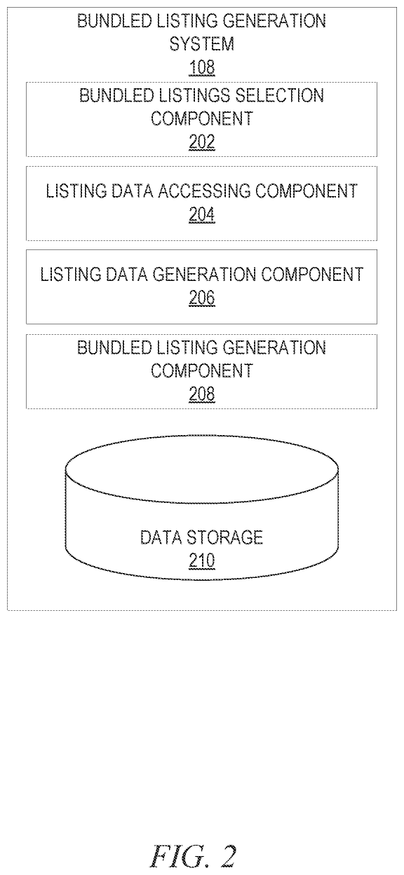

FIG. 2 is a block diagram of a bundled listing generation system 108, according to some example embodiments. To avoid obscuring the inventive subject matter with unnecessary detail, various functional components (e.g., modules) that are not germane to conveying an understanding of the inventive subject matter have been omitted from FIG. 2. However, a skilled artisan will readily recognize that various additional functional components may be supported by the bundled listing generation system 108 to facilitate additional functionality that is not specifically described herein. Furthermore, the various functional modules depicted in FIG. 2 may reside on a single computing device or may be distributed across several computing devices in various arrangements such as those used in cloud-based architectures.

As shown, the bundled listing generation system 108 includes a bundled listings selection component 202, a listing data accessing component 204, a listing data generation component 206, a bundled listing generation component 208, and a data storage 210.

The bundled listings selection component 202 identifies listings posted by the online marketplace service 106 for use in generating a bundled listing. A bundled listing includes items offered for sale in two or more separate listings posted by the online marketplace service 106 that are listed in the bundled listing for a single sale price. For example, a bundled listing may offer a shirt from one listing and pants from another listing together as a bundle for a single sale price. A bundled listing may include two or more (e.g., 2, 3, 4, etc.) items and may be generated based on two or more listings.

The bundled listings selection component 202 identifies items to include in a bundled listing as well as the listings offering the item for sale to be bundled. An item may be listed for sale in multiple listings posted to the online marketplace and by multiple sellers. Accordingly, the bundled listings selection component 202 selects the specific listings to associated with the bundled listing such that purchase of the bundled listing will be fulfilled with the item included in the selected listing and by the corresponding seller. When someone makes a purchase, corresponding specific listings are fulfilled based on the seller configurations and buyer inputs. In other words, if an auction or “Best offer” bundle is purchased when specific listings are by two different sellers, the final amount can be split in multiple ways, more commonly, the system proportionately divides the price based on seller's configuration and buyer's input. And to arrive at the desired deal for both buyer and seller, this system automatically takes care of any communication, negotiation and coordination with multiple sellers.

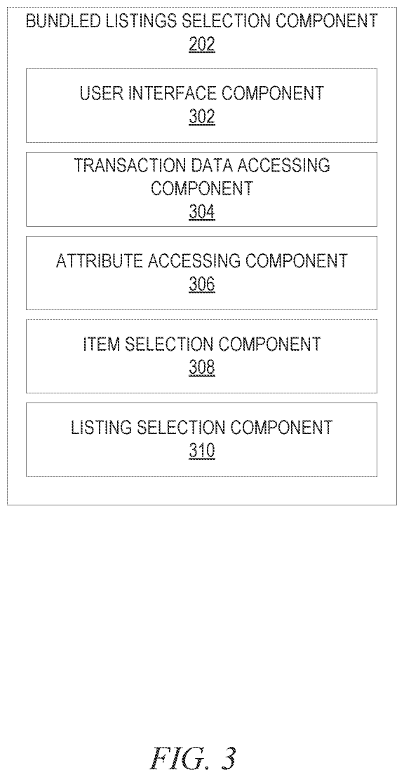

The bundled listings selection component 202 may select the items and listings in various ways, as will be discussed in greater detail below in relation to FIG. 3. In any case, the bundled listings selection component 202 provides data identifying the selected items and/or listings to the other components of the bundled listing generation system 108 for use in generating a bundled listing. For example, the bundled listings selection component 202 may provide unique listing identifiers for the selected listings and/or item identifiers for the items to the other components. The bundled listings selection component 202 may also store the data identifying the selected items and/or listings in the data storage 210, where it can be accessed by the other components.

The listing data accessing component 204 accesses listing data associated with the listings selected by the bundled listings selection component 202. The listing data includes data describing the items offered for sale by the listing, terms of the sale, sale price, seller, and the like. For example, the listing data may include data provided by the seller that generated the listing, such as an item description, listing title, sale price, shipping cost, images, and the like. The listing data may also include data identifying the seller, such as an account identifier associated with the seller, as well as data describing the seller, such as the seller's location, rating, and the like.

The listing data accessing component 204 accesses the listing data from the online marketplace service 106 and/or the data storage 210. For example, the listing data accessing component 204 may use the unique listing identifiers associated with the listings to request the listing data from the online marketplace service 106 and/or search for the listing data in data storage 210. The listing data accessing component 204 provides the listing data to the other components of the bundled listing generation system 108 and/or stores the listing data in the data storage 210.

The listing data generation component 206 generates listing data for a bundled listing based on the listing data gathered by the listing data accessing component 204. The listing data generated for a bundled listing may describe the bundled items being offered for sale by the bundled listing as well as the offered terms associated with bundled listing. For example, the listing data may include an item description describing the bundled items, images of the items, a listing title, and the like. The listing data may also include a purchase price for purchasing the bundled items, a shipping cost, return policy, and the like.

The listing data generation component 206 may generate the listing data for the bundled listing by aggregating the listing data for the individual listings identified by the bundled listings selection component 202. For example, the listing data generation component 206 may aggregate the item images, item description, and listing title from each of the individual listings. In some embodiments, the listing data generation component 206 may aggregate all of the listing data from each of the listings, such as by aggregating all of the item images, item description, etc.

The listing data generation component 206 may aggregate a portion of the listing data from each of the listings. For example, the listing data generation component 206 may aggregate the listing data based on aggregation configurations that dictate how the listing data from the individual listings should be aggregated into listing data for the bundled listing. The aggregation configurations can include constraints for aggregating listing data, such as by indicating a maximum number of item images, maximum item description length, maximum listing title, and the like, for the bundled listing and/or for selecting listing data from the individual listings. For example, the aggregation configurations may dictate that a maximum of 3 images be used from each individual listing to generate the listing data for the bundled listing and/or that the listing data for the bundled listing include a maximum of 6 images. The aggregation configurations may dictate that a maximum of 500 characters of item description be used from each individual listing to generate the listing data for the bundled listing and/or that the listing data for the bundled listing include a maximum of 1000 characters of item description.

The listing data generation component 206 may similarly generate the sale price, shipping price, and/or other terms associated with the bundled listing by aggregating the listing data from the individual listings. For example, the listing data generation component 206 may generate the sale price for the bundled listing by summing the sale prices from the individual listing. In some embodiments a seller may define a bundled sale price for an item that is to be used in a bundled listing. The bundled sale price may be lower than the sale price established for the individual listing. In this type of embodiment, the listing data generation component 206 generates the sale price for the bundled listing by summing the bundled sale prices for the individual listings.

The listing data generation component 206 provides the listing data generated for the bundled listing to the bundled listing generation component 208. In turn, the bundled listing generation component 208 generates the bundled listing based on the listing data generated by the listing data generation component 206. For example, the bundled listing generation component 208 communicates with the online marketplace service 106 to cause generation of the bundled listing. The bundled listing may be included to the listings posted to the online marketplace such that the bundled listing may be searched for and accessed by multiple users of the online marketplace. The bundled listing may be presented to a single user of the online marketplace. For example, the bundled listing may be presented to the user while the user is using the online marketplace.

FIG. 3 is a block diagram of a bundled listings selection component 202, according to some example embodiments. To avoid obscuring the inventive subject matter with unnecessary detail, various functional components (e.g., modules) that are not germane to conveying an understanding of the inventive subject matter have been omitted from FIG. 3. However, a skilled artisan will readily recognize that various additional functional components may be supported by the bundled listings selection component 202 to facilitate additional functionality that is not specifically described herein. Furthermore, the various functional modules depicted in FIG. 3 may reside on a single computing device or may be distributed across several computing devices in various arrangements such as those used in cloud-based architectures.

The bundled listings selection component 202 identifies listings posted by the online marketplace service 106 for use in generating a bundled listing. A bundled listing includes items offered for sale in two or more separate listings posted by the online marketplace service 106 that are listed in the bundled listing for a single sale price. For example, a bundled listing may offer a shirt from one listing and pants from another listing together as a bundle for a single sale price. A bundled listing may include two or more (e.g., 2, 3, 4, etc.) items and may be generated based on two or more listings.

The bundled listings selection component 202 identifies items to include in a bundled listing as well as the listings offering the item for sale to be bundled. An item may be listed for sale in multiple listings posted to the online marketplace and by multiple sellers. Accordingly, the bundled listings selection component 202 selects the specific listings to associated with the bundled listing such that purchase of the bundled listing will be fulfilled with the item included in the selected listing and by the corresponding seller.

The bundled listings selection component 202 may select the items and listings in various ways, as will be discussed in greater detail below. As shown, the bundled listings selection component 202 includes a user interface component 302, a transaction data accessing component 304, an attribute accessing component 306, an item selection component 308, and a listing selection component 310.

The user interface component 302 provides a user interface that enables users of the online marketplace service 106 to select items to be included in a bundled listing. For example, the user interface may include user interface elements, such as buttons, text boxes, and the like, that enable a user to identify items to be included in a bundled listing. In some embodiments, the user interface may be a search interface for executing a search query. In any case, the user may use the user interface to identify items that the user would like to include in a bundled listing. for example, the user may enter the names of the items into a text box, such as by entering “shirt and pants.”

The user interface component 302 provides the data provided by the user to the other components of the bundled listings selection component 202 for use in identifying listings for generating a bundled listing.

The transaction data accessing component 304 accesses transaction data describing transactions performed in relation to use of an online marketplace. The transaction data may include any type of data describing use of an online marketplace, such as data identifying purchases, listing views, search queries, and the like. The transaction data may be related to multiple users of the online marketplace or a single user of the online marketplace.

The transaction data accessing component 304 accesses the transaction data from the online marketplace service 106 and/or from the data storage 210. The transaction data accessing component 304 may access transaction data associated with a designated period of time and/or a designated user or set of users. The transaction data accessing component 304 may provide the transaction data to the other components of the bundled listings selection component 202 for use in selecting listings to for generating a bundled listing.

The attribute accessing component 306 accesses listing attributes associated with listings posted to an online marketplace. The listing attributes include data describing listings posted to the online marketplace. For example, the listing attributes may include attributes describing the items, sellers, geographic location of the items, and the like. The attribute accessing component 306 accesses the listing attributes from the online marketplace service 106 and/or from the data storage 210. The attribute accessing component 306 may access listing attributes associated with listings currently posted to the online marketplace and/or listing that were previously posted to the online marketplace. The attribute accessing component 306 may access listings posted during a designated period of time and/or viewed/accessed by a particular user or set of users. The attribute accessing component 306 may provide the listing attributes to the other components of the bundled listings selection component 202 for use in selecting listings to for generating a bundled listing.

The item selection component 308 selects items to include in a bundled listing. The item selection component 308 selects the items provided by the other components of the bundled listings selection component 202. For example, the item selection component 308 may select the items based on items selected by a user using the user interface provided by the user interface component 302.

The item selection component 308 may select the items based on the transaction data accessed by the transaction data accessing component 304. For example, the item selection component 308 may analyze the transaction data to identify items that are purchased together commonly. The item selection component 308 may analyze the transaction data to identify items that the user has viewed recently or viewed within a single session.

In some embodiments, the item selection component 308 selects the items based on listing attributes describing the items. For example, the item selection component 308 may analyze the listing attributes to identify similar items and/or items that complement each other.

In some embodiments, the item selection component 308 may select the items based on a combination of the above described factors. For example, the item selection component 308 may generate a score for pairs of items indicating how likely the items are to be purchased together based on the above described data. The item selection component 308 may calculate the score using any of a variety of algorithms. Further, the item selection component 308 may apply various weights to the previously described criteria when selecting the items to include in the clustered listing. In some embodiments, the score may be presented to a user in order to help the user with the purchase decision.

The item selection component 308 provides data identifying the selected items to the listing selection component 310. In turn, the listing selection component 310 selects listings offering the selected items for sale to use in the bundled listing. An item may be listed for sale in multiple listings posted to the online marketplace and by multiple sellers. Accordingly, the listing selection component 310 selects the specific listings to associate with the bundled listing such that purchase of the bundled listing will be fulfilled with the item included in the selected listing and by the corresponding seller.

In some embodiments, the listing selection component 310 selects the listings based on the sellers associated with the listings. For example, the listing selection component 310 may select listings that are associated with the same seller and/or sellers that are geographically close to each other and/or the potential buyer. Selecting listings offered by the same seller or geographically close sellers may facilitate an easier transaction as shipping costs may be combined or similar for each of the bundled items.

In some embodiments, the listing selection component 310 selects the listings based on the sale prices or bundled sale prices associated with the listings. For example, the listing selection component 310 may select listing to provide a lowest possible sale price for the bundled listing or a sale price that is below a threshold sale price (e.g., less than $100, less than $1,000, less than a threshold sale price input by the buyer, etc.). The listing selection component 310 may determine the sale price based on the listed sale prices alone or consider the shipping cost associate with each listing as well.

In some embodiments, the listing selection component 310 may select the listings based on ratings associated with the sellers. For example, the listing selection component 310 may select listing to provide a highest possible rating for the bundled listing or a rating that meets or exceeds a threshold rating (e.g., meets or exceeds a five star rating, meets or exceeds a four star rating, etc.).

In some embodiments, the listing selection component 310 may select the listings based on a condition of the items. For example, the listing selection component 310 may select listings that are associated with items in a similar condition, such as new items, used item, mint condition, fair condition, and the like.

These are just a few examples and are not meant to be limiting. The listing selection component 310 may select the listings based on any of a variety of factors or combination of factors.

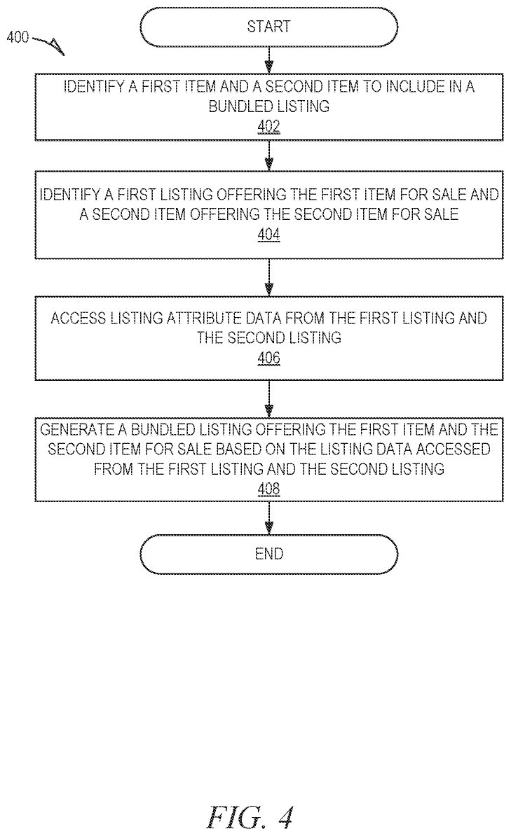

FIG. 4 is a flowchart showing a method 400 for bundled listing generation, according to some example embodiments. The method 400 may be embodied in computer readable instructions for execution by one or more processors such that the operations of the method 400 may be performed in part or in whole by the bundled listing generation system 108; accordingly, the method 400 is described below by way of example with reference thereto. However, it shall be appreciated that at least some of the operations of the method 400 may be deployed on various other hardware configurations and the method 400 is not intended to be limited to the bundled listing generation system 108.

At operation 402, the item selection component 308 identifies a first item and a second item to include in a bundled listing. The item selection component 308 selects the items provided by the other components of the bundled listings selection component 202. For example, the item selection component 308 may select the items based on items selected by a user using the user interface provided by the user interface component 302.

The item selection component 308 may select the items based on the transaction data accessed by the transaction data accessing component 304. For example, the item selection component 308 may analyze the transaction data to identify items that are purchased together commonly. The item selection component 308 may analyze the transaction data to identify items that the user has viewed recently or viewed within a single session.

In some embodiments, the item selection component 308 selects the items based on listing attributes describing the items. For example, the item selection component 308 may analyze the listing attributes to identify similar items and/or items that complement each other.

In some embodiments, the item selection component 308 may select the items based on a combination of the above described factors. For example, the item selection component 308 may generate a score for pairs of items indicating how likely the items are to be purchased together based on the above described data. The item selection component 308 may calculate the score using any of a variety of algorithms. Further, the item selection component 308 may apply various weights to the previously described criteria when selecting the items to include in the clustered listing.

The item selection component 308 provides data identifying the selected items to the listing selection component 310. At operation 404, the listing selection component 310 identifies a first listing offering the first item for sale a second item offering the second item for sale. An item may be listed for sale in multiple listings posted to the online marketplace and by multiple sellers. Accordingly, the listing selection component 310 selects the specific listings to associate with the bundled listing such that purchase of the bundled listing will be fulfilled with the item included in the selected listing and by the corresponding seller.

In some embodiments, the listing selection component 310 selects the listings based on the sellers associated with the listings. For example, the listing selection component 310 may select listings that are associated with the same seller and/or sellers that are geographically close to each other and/or the potential buyer. Selecting listings offered by the same seller or geographically close sellers may facilitate an easier transaction as shipping costs may be combined or similar for each of the bundled items.

In some embodiments, the listing selection component 310 selects the listings based on the sale prices or bundled sale prices associated with the listings. For example, the listing selection component 310 may select listing to provide a lowest possible sale price for the bundled listing or a sale price that is below a threshold sale price (e.g., less than $100, less than $1,000, less than a threshold sale price input by the buyer, etc.). The listing selection component 310 may determine the sale price based on the listed sale prices alone or consider the shipping cost associate with each listing as well.

In some embodiments, the listing selection component 310 may select the listings based on ratings associated with the sellers. For example, the listing selection component 310 may select listing to provide a highest possible rating for the bundled listing or a rating that meets or exceeds a threshold rating (e.g., meets or exceeds a five star rating, meets or exceeds a four star rating, etc.).

In some embodiments, the listing selection component 310 may select the listings based on a condition of the items. For example, the listing selection component 310 may select listings that are associated with items in a similar condition, such as new items, used item, mint condition, fair condition, and the like.

These are just a few examples and are not meant to be limiting. The listing selection component 310 may select the listings based on any of a variety of factors or combination of factors.

At operation 406, the listing data accessing component 204 accesses listing data from the first listing and the second listing. The listing data includes data describing the items offered for sale by the listing, terms of the sale, sale price, seller, and the like. For example, the listing data may include data provided by the seller that generated the listing, such as an item description, listing title, sale price, shipping cost, images, and the like. The listing data may also include data identifying the seller, such as an account identifier associated with the seller, as well as data describing the seller, such as the seller's location, rating, and the like.

The listing data accessing component 204 accesses the listing data from the online marketplace service 106 and/or the data storage 210. For example, the listing data accessing component 204 may use the unique listing identifiers associated with the listings to request the listing data from the online marketplace service 106 and/or search for the listing data in data storage 210. The listing data accessing component 204 provides the listing data to the other components of the bundled listing generation system 108 and/or stores the listing data in the data storage 210.

The listing data generation component 206 generates listing data for a bundled listing based on the listing data gathered by the listing data accessing component 204. The listing data generated for a bundled listing may describe the bundled items being offered for sale by the bundled listing as well as the offered terms associated with bundled listing. For example, the listing data may include an item description describing the bundled items, images of the items, a listing title, and the like. The listing data may also include a purchase price for purchasing the bundled items, a shipping cost, return policy, and the like.

At operation 408, the bundles listing generation system 108 generates a bundled listing offering the first item and the second item for sale based on the listing data accessed from the first listing and the second listing. For example, the listing data generation component 206 generates listing data for the bundled listing based on the listing data gathered by the listing data accessing component 204. The listing data generated for a bundled listing may describe the bundled items being offered for sale by the bundled listing as well as the offered terms associated with bundled listing. For example, the listing data may include an item description describing the bundled items, images of the items, a listing title, and the like. The listing data may also include a purchase price for purchasing the bundled items, a shipping cost, return policy, and the like.

The listing data generation component 206 may generate the listing data for the bundled listing by aggregating the listing data for the individual listings identified by the bundled listings selection component 202. For example, the listing data generation component 206 may aggregate the item images, item description, and listing title from each of the individual listings. In some embodiments, the listing data generation component 206 may aggregate all of the listing data from each of the listings, such as by aggregating all of the item images, item description, etc.

The listing data generation component 206 may aggregate a portion of the listing data from each of the listings. For example, the listing data generation component 206 may aggregate the listing data based on aggregation configurations that dictate how the listing data from the individual listings should be aggregated into listing data for the bundled listing. The aggregation configurations can include constraints for aggregating listing data, such as by indicating a maximum number of item images, maximum item description length, maximum listing title, and the like, for the bundled listing and/or for selecting listing data from the individual listings. For example, the aggregation configurations may dictate that a maximum of 3 images be used from each individual listing to generate the listing data for the bundled listing and/or that the listing data for the bundled listing include a maximum of 6 images. The aggregation configurations may dictate that a maximum of 500 characters of item description be used from each individual listing to generate the listing data for the bundled listing and/or that the listing data for the bundled listing include a maximum of 1000 characters of item description.

The listing data generation component 206 may similarly generate the sale price, shipping price, and/or other terms associated with the bundled listing by aggregating the listing data from the individual listings. For example, the listing data generation component 206 may generate the sale price for the bundled listing by summing the sale prices from the individual listing. In some embodiments a seller may define a bundled sale price for an item that is to be used in a bundled listing. The bundled sale price may be lower than the sale price established for the individual listing. In this type of embodiment, the listing data generation component 206 generates the sale price for the bundled listing by summing the bundled sale prices for the individual listings.

The listing data generation component 206 provides the listing data generated for the bundled listing to the bundled listing generation component 208. In turn, the bundled listing generation component 208 generates the bundled listing based on the listing data generated by the listing data generation component 206. For example, the bundled listing generation component 208 communicates with the online marketplace service 106 to cause generation of the bundled listing. The bundled listing may be included to the listings posted to the online marketplace such that the bundled listing may be searched for and accessed by multiple users of the online marketplace. The bundled listing may be presented to a single user of the online marketplace, example, the bundled listing may be presented to the user while the user is using the online marketplace.

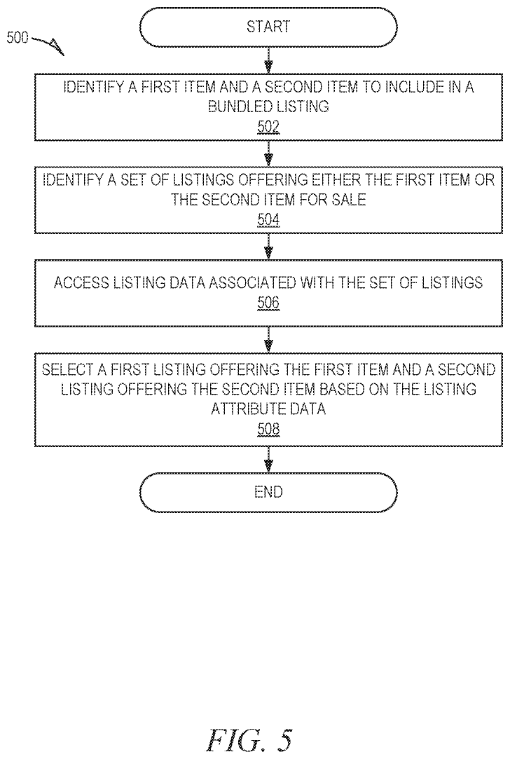

FIG. 5 is a flowchart showing a method 500 of selecting individual listings for generating a bundled listing, according to some example embodiments. The method 500 may be embodied in computer readable instructions for execution by one or more processors such that the operations of the method 500 may be performed in part or in whole by the bundled listing generation system 108; accordingly, the method 500 is described below by way of example with reference thereto. However, it shall be appreciated that at least some of the operations of the method 500 may be deployed on various other hardware configurations and the method 500 is not intended to be limited to the bundled listing generation system 108.

At operation 502, the item selection component 308 identifies a first item and a second item to include in a bundled listing. The item selection component 308 selects the items provided by the other components of the bundled listings selection component 202. For example, the item selection component 308 may select the items based on items selected by a user using the user interface provided by the user interface component 302.

The item selection component 308 may select the items based on the transaction data accessed by the transaction data accessing component 304. For example, the item selection component 308 may analyze the transaction data to identify items that are purchased together commonly. The item selection component 308 may analyze the transaction data to identify items that the user has viewed recently or viewed within a single session.

In some embodiments, the item selection component 308 selects the items based on listing attributes describing the items. For example, the item selection component 308 may analyze the listing attributes to identify similar items and/or items that complement each other.

In some embodiments, the item selection component 308 may select the items based on a combination of the above described factors. For example, the item selection component 308 may generate a score for pairs of items indicating how likely the items are to be purchased together based on the above described data. The item selection component 308 may calculate the score using any of a variety of algorithms. Further, the item selection component 308 may apply various weights to the previously described criteria when selecting the items to include in the clustered listing.

The item selection component 308 provides data identifying the selected items to the listing selection component 310.

At operation 504, the listing selection component 310 identifies a set of listings offering either the first item or the second item for sale. For example, the listing selection component 310 uses data identifying the selected items, such as unique item identifiers, to search the online marketplace service 106 and/or the data storage 210 for listings offering the items for sale. The listing selection component 310 provides data identifying the listings to the attribute accessing component 306.

At operation 506, the attribute accessing component 306 accesses listing attribute data associated with the set of listings. The listing attributes include data describing listings posted to the online marketplace. For example, the listing attributes may include attributes describing the items, sellers, geographic location of the items, and the like. The attribute accessing component 306 accesses the listing attributes from the online marketplace service 106 and/or from the data storage 210. The attribute accessing component 306 may access listing attributes associated with listings currently posted to the online marketplace and/or listing that were previously posted to the online marketplace. The attribute accessing component 306 may access listings posted during a designated period of time and/or viewed/accessed by a particular user or set of users.

At operation 508, the listing selection component 310 selects a first listing offering the first item and a second listing offering the second item based on the listing attribute data.

### Software Architecture

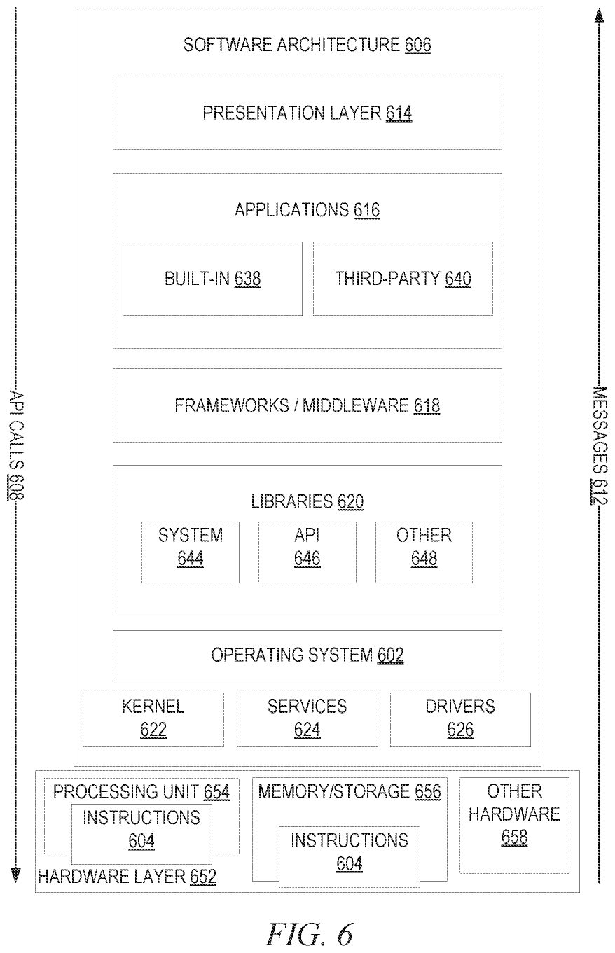

FIG. 6 is a block diagram illustrating an example software architecture 606, which may be used in conjunction with various hardware architectures herein described. FIG. 6 is a non-limiting example of a software architecture 606 and it will be appreciated that many other architectures may be implemented to facilitate the functionality described herein. The software architecture 606 may execute on hardware such as machine 700 of FIG. 7 that includes, among other things, processors 704, memory 714, and (input/output) I/O components 718. A representative hardware layer 652 is illustrated and can represent, for example, the machine 700 of FIG. 7. The representative hardware layer 652 includes a processing unit 654 having associated executable instructions 604. Executable instructions 604 represent the executable instructions of the software architecture 606, including implementation of the methods, components, and so forth described herein. The hardware layer 652 also includes memory and/or storage modules 656, which also have executable instructions 604. The hardware layer 652 may also comprise other hardware 658.

In the example architecture of FIG. 6, the software architecture 606 may be conceptualized as a stack of layers where each layer provides particular functionality. For example, the software architecture 606 may include layers such as an operating system 602, libraries 620, frameworks/middleware 618, applications 616, and a presentation layer 614. Operationally, the applications 616 and/or other components within the layers may invoke Application Programming interface (API) calls 608 through the software stack and receive a response such as messages 612 in response to the API calls 608, The layers illustrated are representative in nature and not all software architectures have all layers. For example, some mobile or special purpose operating systems may not provide a frameworks/middleware 618, while others may provide such a layer. Other software architectures may include additional or different layers.

The operating system 602 may manage hardware resources and provide common services. The operating system 602 may include, for example; a kernel 622, services 624, and drivers 626, The kernel 622 may act as an abstraction layer between the hardware and the other software layers. For example, the kernel 622 may be responsible for memory management, processor management (e.g., scheduling), component management, networking, security settings, and so on. The services 624 may provide other common services for the other software layers. The drivers 626 are responsible for controlling or interfacing with the underlying hardware. For instance, the drivers 626 include display drivers, camera drivers, Bluetooth® drivers, flash memory drivers, serial communication drivers (e.g., Universal Serial Bus (USB) drivers), Wi-Fi® drivers, audio drivers, power management drivers, and so forth, depending on the hardware configuration.

The libraries 620 provide a common infrastructure that is used by the applications 616 and/or other components and/or layers. The libraries 620 provide functionality that allows other software components to perform tasks in an easier fashion than to interface directly with the underlying operating system 602 functionality (e.g., kernel 622, services 624, and/or drivers 626). The libraries 620 may include system libraries 644 (e.g., C standard library) that may provide functions such as memory allocation functions, string manipulation functions, mathematical functions, and the like. In addition, the libraries 620 may include API libraries 646 such as media libraries (e.g., libraries to support presentation and manipulation of various media format such as MPEG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 620 may also include a wide variety of other libraries 648 to provide many other APIs to the applications 616 and other software components/modules.

The frameworks/middleware 618 (also sometimes referred to as middleware) provide a higher-level common infrastructure that may be used by the applications 616 and/or other software components/modules. For example, the frameworks/middleware 618 may provide various graphical user interface (GUI) functions, high-level resource management, high-level location services, and so forth. The frameworks/middleware 618 may provide a broad spectrum of other APIs that may be used by the applications 616 and/or other software components/modules, some of which may be specific to a particular operating system 602 or platform.

The applications 616 include built-in applications 638 and/or third-party applications 640. Examples of representative built-in applications 638 may include, but are not limited to, a contacts application, a browser application, a book reader application, a location application, a media application, a messaging application, and/or a game application. Third-party applications 640 may include an application developed using the ANDROID™ or IOS™ software development kit (SDK) by an entity other than the vendor of the particular platform, and may be mobile software running on a mobile operating system such as IOS™, ANDROID™, WINDOWS® Phone, or other mobile operating systems. The third-party applications 640 may invoke the API calls 608 provided by the mobile operating system (such as operating system 602) to facilitate functionality described herein.

The applications 616 may use built in operating system functions (e.g., kernel 622, services 624, and/or drivers 626), libraries 620, and frameworks/middleware 618 to create UIs to interact with users of the system. Alternatively, or additionally, in some systems, interactions with a user may occur through a presentation layer, such as presentation layer 614. In these systems, the application/component “logic” can be separated from the aspects of the application/component that interact with a user.

FIG. 7 is a block diagram illustrating components of a machine 700, according to some example embodiments, able to read instructions 604 from a machine-readable medium (e.g., a machine-readable storage medium) and perform any one or more of the methodologies discussed herein. Specifically, FIG. 7 shows a diagrammatic representation of the machine 700 in the example form of a computer system, within which instructions 710 (e.g., software, a program, an application, an applet, an app, or other executable code) for causing the machine 700 to perform any one or more of the methodologies discussed herein may be executed. As such, the instructions 710 may be used to implement modules or components described herein. The instructions 710 transform the general, non-programmed machine 700 into a particular machine 700 programmed to carry out the described and illustrated functions in the manner described. In some embodiments, the machine 700 operates as a standalone device or may be coupled (e.g., networked) to other machines. In a networked deployment, the machine 700 may operate in the capacity of a server machine or a client machine in a server-client network environment, or as a peer machine in a peer-to-peer (or distributed) network environment. The machine 700 may comprise, but not be limited to, a server computer, a client computer, a PC, a tablet computer, a laptop computer, a netbook, a set-top box (SIB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine 700 capable of executing the instructions 710, sequentially or otherwise, that specify actions to be taken by machine 700. Further, while only a single machine 700 is illustrated, the term “machine” shall also be taken to include a collection of machines that individually or jointly execute the instructions 710 to perform any one or more of the methodologies discussed herein.

The machine 700 may include processors 704, memory/storage 706, and I/O components 718, which may be configured to communicate with each other such as via a bus 702. The memory/storage 706 may include a memory 714, such as a main memory, or other memory storage, and a storage unit 716, both accessible to the processors 704 (e.g., processor 708, processor 712) such as via the bus 702. The storage unit 716 and memory 714 store the instructions 710 embodying any one or more of the methodologies or functions described herein. The instructions 710 may also reside, completely or partially, within the memory 714, within the storage unit 716, within at least one of the processors 704 (e.g., within the processor's cache memory), or any suitable combination thereof, during execution thereof by the machine 700. Accordingly, the memory 714, the storage unit 716, and the memory of processors 704 are examples of machine-readable media.

The I/O components 718 may include a wide variety of components to receive input, provide output, produce output, transmit information, exchange information, capture measurements, and so on. The specific I/O components 718 that are included in a particular machine 700 will depend on the type of machine. For example, portable machines such as mobile phones will likely include a touch input device or other such input mechanisms, while a headless server machine will likely not include such a touch input device. It will be appreciated that the I/O components 718 may include many other components that are not shown in FIG. 7, The I/O components 718 are grouped according to functionality merely for simplifying the following discussion and the grouping is in no way limiting. In various example embodiments, the I/O components 718 may include output components 726 and input components 728. The output components 726 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 728 may include alphanumeric input components (e.g., a keyboard, a touch screen configured to receive alphanumeric input, a photo-optical keyboard, or other alphanumeric: input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 718 may include biometric components 730, motion components 734, environmental components 736, or position components 738 among a wide array of other components. For example, the biometric components 730 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 734 may include acceleration sensor components (e.g., accelerometer), gravitation sensor components, rotation sensor components (e.g., gyroscope), and so forth. The environmental components 736 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 738 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 718 may include communication components 740 operable to couple the machine 700 to a network 732 or devices 720 via coupling 724 and coupling 722, respectively. For example, the communication components 740 may include a network interface component or other suitable device to interface with the network 732. In further examples, communication components 740 may include wired communication components, wireless communication components, cellular communication components, near field communication (NFC) components, Bluetooth®, components (e.g., Bluetooth®, Low Energy), Wi-Fi® components, and other communication components to provide communication via other modalities. The devices 720 may be another machine or any of a wide variety of peripheral devices (e.g., a peripheral device coupled via a USB).

Moreover, the communication components 740 may detect identifiers or include components operable to detect identifiers. For example, the communication components 740 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 740, such as, location via Internet Protocol (IP) geo-location, location via Wi-Fi® signal triangulation, location via detecting a NFC beacon signal that may indicate a particular location, and so forth.

### Glossary

“CARRIER SIGNAL” in this context refers to any intangible medium that is capable of storing, encoding, or carrying instructions 710 for execution by the machine 700, and includes digital or analog communications signals or other intangible medium to facilitate communication of such instructions 710. Instructions 710 may be transmitted or received over the network 732 using a transmission medium via a network interface device and using any one of a number of well-known transfer protocols.

“CLIENT DEVICE” in this context refers to any machine 700 that interfaces to a communications network 732 to obtain resources from one or more server systems or other client devices. A client device 102, 104 may be, but is not limited to, mobile phones, desktop computers, laptops, PDAs, smart phones, tablets, ultra books, netbooks, laptops, multi-processor systems, microprocessor-based or programmable consumer electronics, game consoles, STBs, or any other communication device that a user may use to access a network 732.

“COMMUNICATIONS NETWORK” in this context refers to one or more portions of a network 732 that may be an ad hoc network, an intranet, an extranet, a virtual private network (VPN), a LAN, a wireless LAN (WLAN), a. WAN, a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network 732 or a portion of a network 732 may include a wireless or cellular network and the coupling may be a Code Division Multiple Access (CDMA) connection, a Global System for Mobile communications (GSM) connection, or other type of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

“MACHINE-READABLE MEDIUM” in this context refers to a component, device or other tangible media able to store instructions 710 and data temporarily or permanently and may include, but is not be limited to, random-access memory (RAM), read-only memory (ROM), buffer memory, flash memory, optical media, magnetic media, cache memory, other types of storage (e.g., erasable programmable read-only memory (EEPROM)), and/or any suitable combination thereof. The term “machine-readable medium” should be taken to include a single medium or multiple media (e.g., a centralized or distributed database, or associated caches and servers) able to store instructions 710. The term “machine-readable medium” shall also be taken to include any medium, or combination of multiple media, that is capable of storing instructions 710 (e.g., code) for execution by a machine 700, such that the instructions 710, when executed by one or more processors 704 of the machine 700, cause the machine 700 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

“COMPONENT” in this context refers to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors 704) may be configured by software (e.g., an application 616 or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application specific integrated circuit (ASIC). A hardware component may also include programmable logic or circuitry that is temporarily configured by software to perform certain operations. For example, a hardware component may include software executed by a general-purpose processor 704 or other programmable processor 704. Once configured by such software, hardware components become specific machines 700 (or specific components of a machine 700) uniquely tailored to perform the configured functions and are no longer general-purpose processors 704. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where a hardware component comprises a general-purpose processor 704 configured by software to become a special-purpose processor, the general-purpose processor 704 may be configured as respectively different special-purpose processors (e.g., comprising different hardware components) at different times. Software accordingly configures a particular processor or processors 704, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses 702) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors 704 that are temporarily configured (e.g., by software) or permanently configured to perform the relevant operations. Whether temporarily or permanently configured, such processors 704 may constitute processor-implemented components that operate to perform one or more operations or functions described herein. As used herein, “processor-implemented component” refers to a hardware component implemented using one or more processors 704. Similarly, the methods described herein may be at least partially processor-implemented, with a particular processor or processors 704 being an example of hardware. For example, at least some of the operations of a method may be performed by one or more processors 704 or processor-implemented components. Moreover, the one or more processors 704 may also operate to support performance of the relevant operations in a “cloud computing” environment or as a “software as a service” (SaaS). For example, at least some of the operations may be performed by a group of computers (as examples of machines 700 including processors 704), with these operations being accessible via a network 732 (e.g., the Internet) and via one or more appropriate interfaces (e.g., an API). The performance of certain of the operations may be distributed among the processors 704, not only residing within a single machine 700, but deployed across a number of machines 700. In some example embodiments, the processors 704 or processor-implemented components may be located in a single geographic location (e.g., within a home environment, an office environment, or a server farm). In other example embodiments, the processors 704 or processor-implemented components may be distributed across a number of geographic locations.

“PROCESSOR” in this context refers to any circuit or virtual circuit physical circuit emulated by logic executing on an actual processor) that manipulates data values according to control signals (e.g., “commands,” “op codes,” “machine code,” etc.) and which produces corresponding output signals that are applied to operate a machine 700. A processor 704 may be, for example, a central processing unit (CPU), a reduced instruction set computing (RISC) processor, a complex instruction set computing (CISC) processor, a graphics processing unit (GPU), a digital signal processor (DSP), an ASIC, a radio-frequency integrated circuit (RFIC) or any combination thereof. A processor may further be a multi-core processor having two or more independent processors 704 (sometimes referred to as “cores”) that may execute instructions 710 contemporaneously.

1. A method comprising:
identifying, by a selection component, a first item and a second item to include as bundled items in a bundled listing;
identifying, by the selection component, a first listing generated by a first seller device offering the first item and a second listing generated by a second seller device offering the second item, the first listing and second listing being online listings accessible from an online service;
extracting and aggregating, by a data generation component, a portion of first listing data from the first listing and a portion of second listing data from the second listing to create aggregated listing data, the aggregating being based on an aggregation configuration that indicates constraints for aggregating listing data including a maximum number of item images and a maximum item description length;
generating, by one or more computer processors associated with a listing generation component, a bundled listing using the aggregated listing data, the bundled listing being a single listing for the bundled items that includes an item description describing both of the bundled items, images for both of the bundled items, and a listing title; and
causing presentation of the bundled listing on a device of a user.

2. The method of claim 1, wherein the first item and the second item to include in the bundled listing are identified by analyzing transaction data to identify items that are commonly purchased together.

3. The method of claim 1, further comprising:
causing presentation of a user interface for generating bundled listings; and
receiving a selection of the first item and the second item, the selection submitted through the user interface.

4. The method of claim 1, wherein generating the bundled listing based on the first listing and the second listing comprises:
generating third listing data based on the first listing data and the second listing data, the third listing data being included in the bundled listing.

5. The method of claim 1, wherein the first listing data and the second listing data include at least one of images of the first item and the second item, sale prices for the first item and the second item, and descriptions of the first item and the second item.

6. The method of claim 1, wherein generating the bundled listing data based on the first listing data and the second listing data comprises:
accessing a first bundled sale price associated with the first listing, the first bundled sale price being lower than a sale price associated with the first listing; and
determining an aggregated sale price for the bundled listing based on the first bundled sale price.

7. The method of claim 1, wherein identifying the first listing offering the first item for sale and the second listing offering the second item for sale comprises:
identifying a first set of listings offering the first item for sale and a second set of listings offering the second item for sale; and
identifying a pair of listings from the first set of listings and the second set of listing that are associated with geographically close sellers, the pair of listings comprising the first item for sale and the second item for sale.

8. The method of claim 1, wherein identifying the first listing offering the first item for sale and the second listing offering the second item for sale comprises:
determining an aggregated sale price for the bundled listing based on a first sale price associated with the first listing and a second sale price associated with the second listing; and
determining that the aggregated sale price is less than a threshold price.

9. A system comprising:
one or more computer processors; and
one or more computer-readable mediums storing instructions that, when executed by the one or more computer processors, cause the system to perform operations comprising:
identifying a first item and a second item to include as bundled items in a bundled listing;
identifying a first listing generated by a first seller device offering the first item and a second listing generated by a second seller device offering the second item, the first listing and second listing being online listings accessible from an online service;
extracting and aggregating a portion of first listing data from the first listing and a portion of second listing data from the second listing to create aggregated listing data, the aggregating being based on an aggregation configuration that indicates constraints for aggregating listing data including a maximum number of item images and a maximum item description length;
generating a bundled listing using the aggregated listing data, the bundled listing being a single listing for the bundled items that includes an item description describing both of the bundled items, images for both of the bundled items, and a listing title; and
causing presentation of the bundled listing on a device of a user.

10. The system of claim 9, wherein the first item and the second item to include in the bundled listing are identified by analyzing transaction data to identify items that the user have recently viewer or viewed within a single session.

11. The system of claim 9, the operations further comprises:
causing presentation of a user interface for generating bundled listings; and
receiving a selection of the first item and the second item, the selection submitted through the user interface.

12. The system of claim 9, wherein generating the bundled listing based on the first listing and the second listing comprises:
generating third listing data based on the first listing data and the second listing data, the third listing data being included in the bundled listing.

13. The system of claim 9, wherein the first listing data and the second listing data include at least one of images of the first item and the second item, sale prices for the first item and the second item, and descriptions of the first item and the second item.

14. The system of claim 9, wherein generating the bundled listing data based on the first listing data and the second listing data comprises:
accessing a first bundled sale price associated with the first listing, the first bundled sale price being lower than a sale price associated with the first listing; and
determining an aggregated sale price for the bundled listing based on the first bundled sale price.

15. The system of claim 9, wherein identifying the first listing offering the first item for sale and the second listing offering the second item for sale comprises:
identifying a first set of listings offering the first item for sale and a second set of listings offering the second item for sale; and
identifying a pair of listings from the first set of listings and the second set of listing that are associated with geographically close sellers, the pair of listings comprising the first item for sale and the second item for sale.

16. The system of claim 9, wherein identifying the first listing offering the first item for sale and the second listing offering the second item for sale comprises:
determining an aggregated sale price for the bundled listing based on a first sale price associated with the first listing and a second sale price associated with the second listing; and
determining that the aggregated sale price is less than a threshold price.

17. A non-transitory computer-readable medium storing instructions that,
when executed by one or more computer processors of one or more computing devices, cause the one or more computing devices to perform operations comprising:
identifying a first item and a second item to include as bundled items in a bundled listing;
identifying a first listing generated by a first seller device offering the first item for sale and a second listing generated by a second seller device offering the second item for sale, the first listing and second listing being online listings accessible from an online service;
extracting and aggregating a portion of first listing data from the first listing and a portion of second listing data from the second listing to create aggregated listing data, the aggregating being based on an aggregation configuration that indicates constraints for aggregating listing data including a maximum number of item images and a maximum item description length;
generating a bundled listing using the aggregated listing data, the bundled listing being a single listing for the bundled items that includes an item description describing both of the bundled items, images for both of the bundled items, and a listing title; and
causing presentation of the bundled listing on a device of a user.

18. The non-transitory computer-readable medium of claim 17, wherein the first item and the second item to include in the bundled listing are identified by analyzing listing attributes to identify similar items or items that complement each other.

19. The non-transitory computer-readable medium of claim 17, the operations further comprises:
causing presentation of a user interface for generating bundled listings; and
receiving a selection of the first item and the second item, the selection submitted through the user interface.

20. The non-transitory computer-readable medium of claim 17, wherein generating the bundled listing based on the first listing and the second listing comprises:
generating third listing data based on the first listing data and the second listing data, the third listing data being included in the bundled listing.
